(19) United States
(12) Patent Application Publication
(10) Pub. No.: US 2020/0248568 A1
(43) Pub. Date: Aug. 6, 2020

(54) TURBINE VANE ASSEMBLY WITH CERAMIC MATRIX COMPOSITE COMPONENTS AND TEMPERATURE MANAGEMENT FEATURES

(71) Applicant: Rolls-Royce plc, London (GB)

(72) Inventors: Michael J. Whittle, London (GB); Anthony Razzell, London (GB); Alexander Wong, London (GB)

(21) Appl. No.: 16/265,572

(22) Filed: Feb. 1, 2019

(51) Int. Cl. F01D 5/18; F01D 5/28; F01D 9/04

(52) U.S. Cl. CPC F01D 5/189; F01D 5/284; F01D 9/041; F05D 2300/17; F05D 2260/20; F05D 2240/12; F05D 2220/32

(57) ABSTRACT

A turbine vane assembly adapted for use in a gas turbine engine includes a support and a turbine vane arranged around the support. The support is made of metallic materials. The turbine vane is made of ceramic matrix composite materials to insulate the metallic materials of the support.

### FIELD OF THE DISCLOSURE

The present disclosure relates generally to vane assemblies for gas turbine engines, and more specifically to vanes that comprise ceramic-containing materials.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Products of the combustion reaction directed into the turbine flow over aerofoils included in stationary vanes and rotating blades of the turbine. The interaction of combustion products with the aerofoils heats aerofoils to temperatures that require the aerofoils to be made from high-temperature resistant materials and/or to be actively cooled by supplying relatively cool air to the vanes and blades. To this end, some aerofoils for vanes and blades are incorporating composite materials adapted to withstand very high temperatures. Design and manufacture of vanes and blades from composite materials presents challenges because of the geometry and strength required for the parts.

### SUMMARY

The present disclosure may comprise one or more of the following features and combinations thereof.

A turbine vane assembly for a gas turbine engine may include a ceramic matrix composite vane, a metallic support strut, and a radiation barrier. The ceramic matrix composite vane may be adapted to conduct hot gases flowing through a primary gas path of the gas turbine engine around the turbine vane assembly during use of the turbine vane assembly. The metallic support strut may be configured to receive force loads applied to the ceramic matrix composite vane by the hot gases during use of the turbine vane assembly.

In some embodiments, the ceramic matrix composite vane may include an outer wall that defines an outer boundary of the primary gas path, an inner wall spaced apart radially from the outer wall relative to an axis to define an inner boundary of the primary gas path, and an aerofoil that extends radially between and interconnects the outer wall and the inner wall. The aerofoil may be formed to define an interior cavity that extends radially into the aerofoil,

In some embodiments, the metallic support strut may be located in the interior cavity formed in the aerofoil. The metallic support strut may be spaced apart from the aerofoil at all locations radially between the outer boundary and the inner boundary of the primary gas path to define a cooling channel between the metallic support strut and the aerofoil.

In some embodiments, the radiation barrier may be located in the cooling channel. The radiation barrier may be spaced apart from the metallic support strut and the aerofoil at all locations radially between the outer boundary and the inner boundary of the primary gas path to reduce an amount of heat transfer to the metallic support strut from radiant and convective heating caused by a temperature difference between the ceramic matrix composite vane and the metallic support strut during use of the turbine vane assembly. In some embodiments, the radiation barrier may be rigid and solid without holes that extend circumferentially or axially through the radiation barrier.

In some embodiments, a surface of the radiation barrier may have a reflectivity equal to or greater than about 0.5. In some embodiments, the radiation barrier may comprise a nickel based alloy.

In some embodiments, an air gap may be located between radiation barrier and the metallic support strut. In some embodiments, an air gap may be located between the radiation barrier and the aerofoil.

In some embodiments, the metallic support strut may include a spar and a load transfer tab. The spar may extend radially into the interior cavity. The load transfer tab may extend circumferentially away from the spar and may engage the aerofoil to receive the force loads applied to the ceramic matrix composite vane by the hot gases during use of the turbine vane assembly. In some embodiments, the load transfer tab may be located radially outward out of the outer boundary.

In some embodiments, the turbine vane assembly may further include a seal. The seal may be located between the aerofoil and the metallic support strut to block fluid from flowing into the cooling channel. In some embodiments, the radiation barrier may be the only component located in the cooling channel radially between the outer boundary and the inner boundary of the primary gas path.

According to an aspect of the present disclosure, a turbine vane assembly for a gas turbine engine may include a vane, a support strut, and a radiation barrier. The vane may extend radially relative to an axis and may be formed to define an interior cavity therein. The support strut may be located in the interior cavity and at least a portion of the support strut may be spaced apart from the vane to define a radially extending cooling channel between the support strut and the vane. The radiation barrier may be located in the cooling channel.

In some embodiments, the vane may include an outer wall having a radial inner surface, an inner wall having a radial outer surface, and an aerofoil that extends radially between and interconnects the outer wall and the inner wall. The radial outer wall may define a radial outer boundary of a gas path, the radial inner wall may define a radial inner boundary of the gas path, and the radiation barrier may extend radially entirely between the radial outer boundary and the radial inner boundary.

In some embodiments, the radiation barrier may extend radially outward beyond the radial outer boundary and radially inward beyond the radial inner boundary. In some embodiments, the radiation barrier may be the only component located in the cooling channel radially between the radial outer surface and the radial inner surface.

In some embodiments, the radiation barrier may have a surface with a reflectivity equal to or greater than about 0.7. In some embodiments, the radiation barrier may be continuous and formed without holes that extend either axially or circumferentially through the radiation barrier.

In some embodiments, the turbine vane assembly may further include a seal. The seal may engage the vane and the support strut to block fluid flow in the cooling channel.

According to an aspect of the present disclosure, a method may include several steps. The method may include providing a metallic support strut, a ceramic matrix composite aerofoil formed to define an interior cavity therein, and a radiation barrier, locating the metallic support strut in the interior cavity of the ceramic matrix composite aerofoil so that at least a portion of the metallic support strut is spaced apart from the ceramic matrix composite aerofoil to define a radially extending cooling channel therebetween, and locating the radiation barrier in the cooling channel so that at least a portion of the radiation barrier is spaced apart from the metallic support strut and the ceramic matrix composite aerofoil to separate the cooling channel into an inner gap and an outer gap.

In some embodiments, the method may include blocking airflow in the cooling channel. In some embodiments, the radiation barrier may have a surface with a reflectivity equal to or greater than about 0.7.

These and other features of the present disclosure will become more apparent from the following description of the illustrative embodiments.

### BRIEF DESCRIPTION OF THE DRAWINGS

FIG. 1 is a perspective view of a turbine vane assembly in accordance with the present disclosure for use in a gas turbine engine with portions broken away to reveal that the turbine vane assembly includes a turbine vane adapted to interact with hot gases, a support strut located within the turbine vane to receive force loads from the turbine vane, and a radiation barrier located between the turbine vane and the support strut to reduce an amount of radiant and convective heat transfer from the turbine vane to the support strut during use of the turbine vane assembly;

FIG. 2 is a cross sectional view of the turbine vane assembly of FIG. 1 taken along line 2-2 showing that the turbine vane comprises ceramic matrix composite materials, that the support strut comprises metallic materials, and that the radiation barrier is spaced apart from the turbine vane and the support strut at all locations in a primary gas path to insulate the support strut from the high temperatures of the turbine vane;

FIG. 3 is a detail view of the turbine vane assembly of FIG. 2 showing that the radiation barrier is spaced apart from the turbine vane and the support strut to reduce the convective and radiant heat transfer to the strut from the turbine vane during use of the turbine vane assembly; and

FIG. 4 is a cross-sectional view of the turbine vane assembly of FIG. 1 taken along line 4-4 showing that the metallic support strut forms a cooling channel between the support strut and the turbine vane and showing that the radiation barrier extends radially along an entire length of a gas path in the cooling channel to separate the cooling channel into an outer gap and an inner gap.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

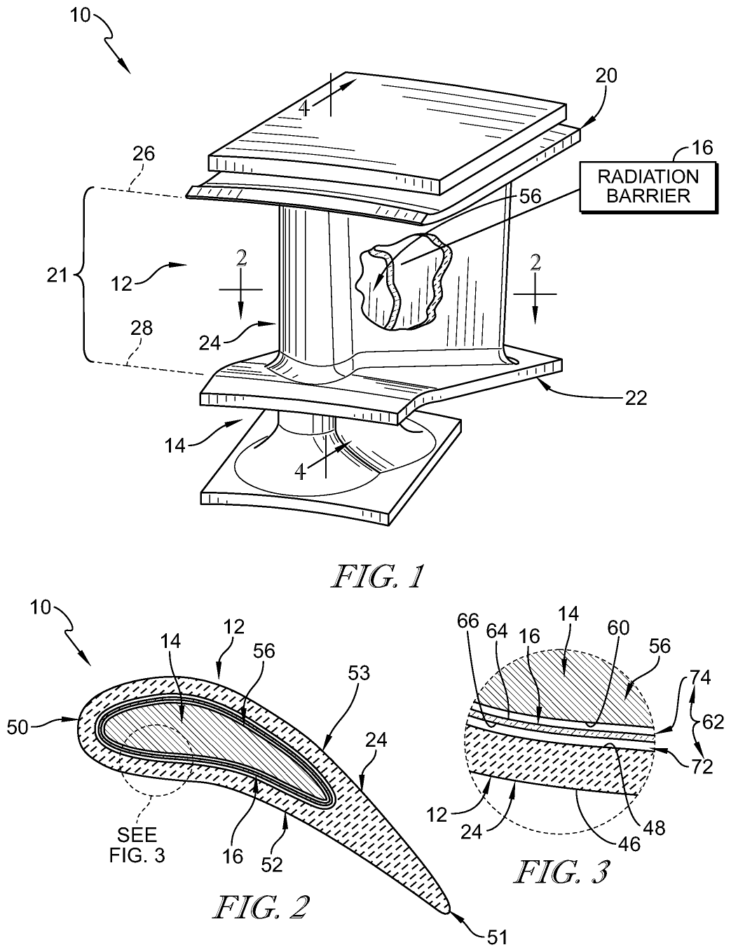

An illustrative turbine vane assembly 10 for use in a gas turbine engine is shown in FIG. 1. The turbine vane assembly 10 extends circumferentially partway about an axis 11 and includes a vane 12, a support strut 14, and a radiation barrier 16 as shown in FIGS. 1-4. The vane 12 is adapted to conduct hot gases flowing through a primary gas path 21 of the gas turbine engine around the turbine vane assembly 10 during use of the turbine vane assembly 10. The support strut 14 is located in an interior cavity 30 of the vane 12 and is configured to receive force loads applied to the vane 12 by the hot gases during use of the turbine vane assembly 10. The radiation barrier 16 is located in a cooling channel 62 formed between the vane 12 and the support strut 14 to reduce heat transfer to the support strut 14 from radiant and convective heating caused by a temperature difference between the vane 12 and the support strut 14 during use of the turbine vane assembly 10.

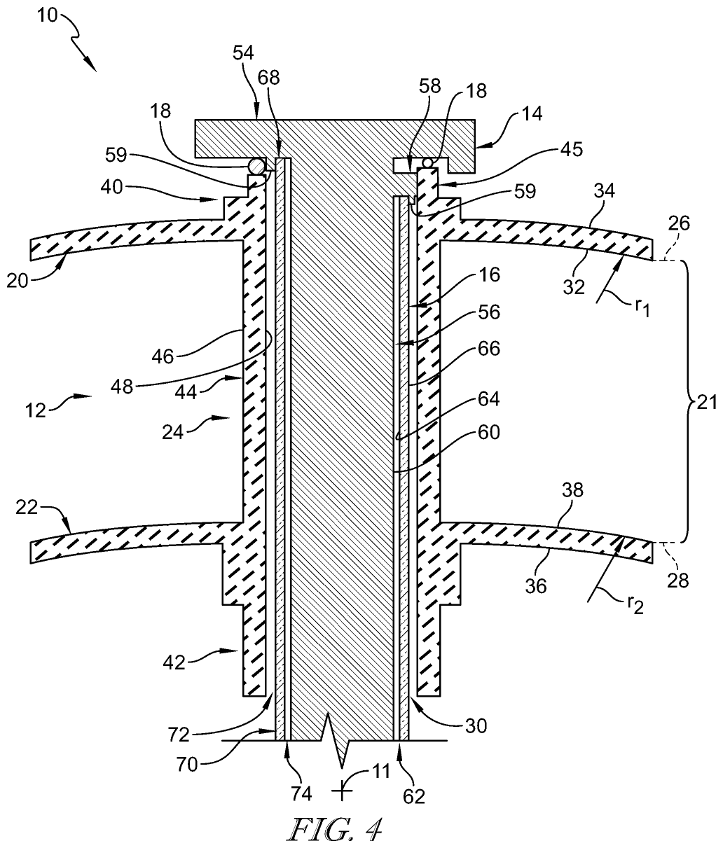

Illustratively, the radiation barrier 16 is spaced apart from the vane 12 and the support strut 14 at all locations radially between an outer boundary 26 and an inner boundary 28 of the primary gas path 21 to separate the cooling channel 62 into an outer gap 72 and an inner gap 74 as suggested in FIG. 4. In the illustrative embodiment, the turbine vane assembly 10 further includes a seal 18 arranged to block or limit fluid flow in the cooling channel 62 to reduce convective heat transfer between the vane 12 and the support strut 14.

The vane 12 comprises ceramic matrix composite materials while the support strut 14 comprises metallic materials in the illustrative embodiment. The ceramic matrix composite vane 12 is adapted to withstand high temperatures, but may have relatively low strength compared to the metallic support strut 14. The support strut 14 provides structural strength to the turbine vane assembly 10 by receiving the force loads applied to the vane 12. The support strut 14 may not be capable of withstanding the high temperatures experienced by the ceramic matrix composite vane 12.

The vane 12 includes an outer wall 20, an inner wall 22, and an aerofoil 24 as shown in FIGS. 1 and 4. The outer wall 20 defines the outer boundary 26 of the primary gas path 21. The inner wall 22 is spaced apart radially from the outer wall 20 relative to the axis 11 to define the inner boundary 28 of the primary gas path 21. The aerofoil 24 extends radially between and interconnects the outer wall 20 and the inner wall 22. The aerofoil 24 is shaped to redirect gases flowing through the primary gas path 21 and shield the support strut 14 from the hot gases in the primary gas path 21. The aerofoil 24 is also formed to define an interior cavity 30 that extends radially into the aerofoil 24 as shown in FIG. 4.

In the illustrative embodiment, the outer wall 20, the inner wall 22, and the aerofoil 24 of the vane 12 are integrally formed from ceramic matrix composite materials. As such, the outer wall 20, the inner wall 22, and the aerofoil 24 provide a single, integral, one-piece vane component 12 as shown in FIG. 4. In other embodiments, the outer wall 20, the inner wall 22, and the aerofoil 24 may be formed as separate components.

The outer wall 20 includes a radial inner surface 32 that defines the outer boundary 26 of the primary gas path 21 and a radial outer surface 34 as shown in FIG. 4. The radial inner surface 32 is located at a first radius r1 relative to the axis 11 and faces the primary gas path 21. The radial outer surface 34 is spaced apart radially from the radial inner surface 32 and faces away from the primary gas path 21.

The inner wall 22 includes a radial inner surface 36 and a radial outer surface 38 that defines the inner boundary 28 of the primary gas path 21 as shown in FIG. 4. The radial outer surface 38 is located at a second radius r2 relative to the axis 11 and faces the primary gas path 21. The radial inner surface 36 is spaced apart from the radial outer surface 38 and faces away from the primary gas path 21.

The aerofoil 24 includes a radial outer end 40, a radial inner end 42, and a body 44 as shown in FIG. 4. The radial outer end 40 extends radially-outward past the outer wall 20 beyond the first radius r1, or the outer boundary 26, and outside the primary gas path 21 in the illustrative embodiment. The radial outer end 40 engages the seal 18 to locate the seal 18 between the support strut 14 and the radial outer end 40 of the aerofoil 24. The radial inner end 42 is spaced apart from the radial outer end 40 relative to the axis 11 and extends radially-inward past the inner wall 22 beyond the second radius r2, or the inner boundary 28, and outside the primary gas path 21. The body 44 extends radially entirely between the first radius r1 and the second radius r2 and interconnects the radial outer end 40 and the radial inner end 42.

The radial outer end 40 of the aerofoil 24 provides a load transfer region 45 as shown in FIG. 4. The load transfer region 45 is located radially outward of the outer boundary 26 outside of the primary gas path 21 in the illustrative embodiment. In other embodiments, the load transfer region 45 is located radially inward of the inner boundary 28 outside the primary gas path 21. The load transfer region 45 is contacted by a load transfer tab 58 of the support strut 14 to transfer loads applied to the vane 12 to the support strut 14 at the radial outer end 40 of the aerofoil 24 outside of the primary gas path 21.

The aerofoil 24 also includes an outer surface 46 and an interior surface 48 as shown in FIG. 3. The outer surface 46 interacts with gases in the primary gas path 21 and extends between the radial inner surface 32 of the outer wall 20 and the radial outer surface 38 of the inner wall 22. The interior surface 48 is spaced apart from the outer surface 46 and defines the interior cavity 30 that extends radially through the aerofoil 24. The outer surface 46 and the interior surface 48 are continuous and formed without holes in the illustrative embodiment. In other embodiments, the outer surface 46 and the interior surface 48 are formed with holes that fluidly connect the interior cavity 30 with the gas path 21.

The outer surface 46 of the aerofoil 24 defines a leading edge 50, a trailing edge 51, a pressure side 52, and a suction side 53 of the vane 12 as shown in FIG. 2. The trailing edge 51 is axially spaced apart from the leading edge 50. The suction side 53 is circumferentially spaced apart from the pressure side 52. The pressure side 52 and the suction side 53 extend between and interconnect the leading edge 50 and the trailing edge 51.

The support strut 14 includes an outer mount panel 54, a spar 56, and the load transfer tab 58 as shown in FIG. 4. The outer mount panel 54 is configured to couple the turbine vane assembly 10 with a casing or carrier of a gas turbine engine and engages the seal 18. The spar 56 extends radially-inwardly from the outer mount panel 54 relative to the axis 11 and into the interior cavity 30 of the vane 12. The load transfer tab 58 extends circumferentially away from the spar 56 relative to the axis 11 and engages the load transfer region 45 of the aerofoil 24 at a location radially outward of the first radius r1, or the outer boundary 26, and outside the primary gas path 21. In other embodiments, the load transfer tab 58 may be located radially inward of the second radius r2, or the inner boundary 28, outside the primary gas path 21.

The support strut 14 further includes radiation barrier contact supports 59 as shown in FIG. 4. The radiation barrier contact supports 59 extend radially inward from one of the outer mount and/or the load transfer tab 58 and locate the radiation barrier 16 between the vane 12 and the support strut 14 in the cooling channel 62.

In the illustrative embodiment, the outer mount panel 54, the spar 56, and the load transfer tab 58 are integrally formed from metallic materials such that the outer mount panel 54, the spar 56, and the load transfer tab 58 are included in a single, integral, one-piece solid support strut 14 component as shown in FIGS. 2-4. In other embodiments, the outer mount panel 54, the spar 56, and the load transfer tab 58 may be formed as separate components.

The spar 56 of the support strut 14 has an outermost surface 60 as shown in FIGS. 2-4. The outermost surface 60 of the spar 56 faces the interior surface 48 of the aerofoil 24. The outermost surface 60 is spaced apart from the aerofoil 24 at all locations radially between the outer boundary 26 and the inner boundary 28 of the primary gas path 21 to define a cooling channel 62 between the outermost surface 60 of the support strut 14 and interior surface 48 of the aerofoil 24. In some embodiments, the spar 56 may be hollow to allow flow of cooling air through the spar 56. In some embodiments, the spar 56 may be hollow and include cooling holes to transmit cooling air to the vane 12 and/or into an inter-disk cavity. In some embodiments, the outermost surface 60 is polished and/or has a low surface roughness.

The radiation barrier 16 is located in the cooling channel 62 between the vane 12 and the support strut 14 as shown in FIGS. 3 and 4. The radiation barrier 16 is spaced apart from the vane 12 and the support strut 14 to insulate the support strut 14 from the heat of the ceramic matrix composite vane 12 during use of the turbine vane assembly 10. The radiation barrier 16 extends entirely circumferentially and axially around the spar 56 as shown in FIG. 2. In the illustrative embodiment, the radiation barrier 16 is the only component located in the cooling channel 62 radially between the outer boundary 26 and the inner boundary 28 as shown in FIGS. 2 and 4. The radiation barrier 16 is configured to reduce the amount of radiant heat transferred from the vane 12 to the support strut 14.

The radiation barrier 16 may reduce the amount of convective heat transferred from the vane 12 to the support strut 14. In some embodiments, the radiation barrier 16 may reduce the amount of conductive heat transferred from the vane 12 to the support strut 14 while in some embodiments conductive heat transfer is addressed with structural design choices. The radiation barrier 16 is solid and formed without pores or holes in the illustrative embodiment. For example, the radiation barrier 16 forms a central passage that extends radially through the radiation barrier 16 to receive the spar 56, but the wall of the radiation barrier 16 is formed without radially, axially, or circumferentially extending holes.

In other embodiments, the radiation barrier 16 may be formed with pores or holes. For example, the radiation barrier 16 may act as an impingement tube such that the wall of the radiation barrier 16 may be formed with radially, axially, or circumferentially extending holes that fluidly connect the outer gap 72 and the inner gap 74.

In the illustrative embodiment, the radiation barrier 16 has a surface with a high reflectivity and a low or no transmissivity and low or no emissivity. The combination of the reflectivity, emissivity, and transmissivity of a surface is equal to 1. The reflectivity is the proportion of heat (radiation) reflected and therefore not absorbed by the surface, the transmissivity is the amount passed through the surface and continues through the coating contributing to the heating of the component feature to be protected, and the emissivity is the proportion absorbed and re-radiated back out. The reflective surface may be surface 64, surface 66, or both surfaces 64, 66.

In some embodiments, the radiation barrier 16 has a surface with a reflectivity between about 0.6 and about 1. In some embodiments, the radiation barrier 16 has a surface with a reflectivity between about 0.1 and about 1. In some embodiments, the radiation barrier 16 has a surface with a reflectivity between about 0.2 and about 0.95. In some embodiments, the radiation barrier 16 has a surface with a reflectivity between about 0.3 and about 0.95. In some embodiments, the radiation barrier 16 has a surface with a reflectivity between about 0.4 and about 0.95. In some embodiments, the radiation barrier 16 has a surface with a reflectivity between about 0.5 and about 0.95. In some embodiments, the radiation barrier 16 has a surface with a reflectivity between about 0.2 and about 0.90. In some embodiments, the radiation barrier 16 has a surface with a reflectivity between about 0.3 and about 0.9. In some embodiments, the radiation barrier 16 has a surface with a reflectivity between about 0.4 and about 0.9. In some embodiments, the radiation barrier 16 has a surface with a reflectivity between about 0.5 and about 0.9. In some embodiments, the radiation barrier 16 has a surface with a reflectivity between about 0.1 and about 0.85. In some embodiments, the radiation barrier 16 has a surface with a reflectivity between about 0.2 and about 0.85. In some embodiments, the radiation barrier 16 has a surface with a reflectivity between about 0.3 and about 0.85. In some embodiments, the radiation barrier 16 has a surface with a reflectivity between about 0.4 and about 0.85. In some embodiments, the radiation barrier 16 has a surface with a reflectivity between about 0.5 and about 0.85.

In some embodiments, the radiation barrier 16 has a surface with a reflectivity between about 0.2 and about 0.8. In some embodiments, the radiation barrier 16 has a surface with a reflectivity between about 0.3 and about 0.8. In some embodiments, the radiation barrier 16 has a surface with a reflectivity between about 0.4 and about 0.8. In some embodiments, the radiation barrier 16 has a surface with a reflectivity between about 0.5 and about 0.8. In some embodiments, the radiation barrier 16 has a surface with a reflectivity between about 0.6 and about 0.8.

In some embodiments, the radiation barrier 16 has a surface with a reflectivity of about 0.7 or more. In some embodiments, the radiation barrier 16 has a surface with a reflectivity in a range of about 0.7 to about 1.0. In some embodiments, the radiation barrier 16 has a surface with a reflectivity in a range of about 0.75 to about 1.0. In some embodiments, the radiation barrier 16 has a surface with a reflectivity in a range of about 0.8 to about 1.0. In some embodiments, the radiation barrier 16 has a surface with a reflectivity of about 0.9 to about 1.0.

In some embodiments, the radiation barrier 16 has a surface with a reflectivity in a range of about 0.7 to about 0.95. In some embodiments, the radiation barrier 16 has a surface with a reflectivity in a range of about 0.65 to 0.95. In some embodiments, the radiation barrier 16 has a surface with a reflectivity in a range of about 0.7 to about 0.9. In some embodiments, the radiation barrier 16 has a surface with a reflectivity between about 0.75 and about 0.95. In some embodiments, the radiation barrier 16 has a surface with a reflectivity between about 0.8 and about 0.95. In some embodiments, the radiation barrier 16 has a surface with a reflectivity between about 0.75 and about 0.9. In some embodiments, the radiation barrier 16 has a surface with a reflectivity between about 0.8 and about 0.9. In some embodiments, the radiation barrier 16 has a surface with a reflectivity between about 0.6 and about 0.7. In some embodiments, the radiation barrier 16 has a surface with a reflectivity between about 0.7 and about 0.85. In some embodiments, the radiation barrier 16 has a surface with a reflectivity between about 0.7 and about 0.9.

In some embodiments, the radiation barrier has a surface with a reflectivity of about 0.1. In some embodiments, the radiation barrier has a surface with a reflectivity of about 0.2. In some embodiments, the radiation barrier has a surface with a reflectivity of about 0.3. In some embodiments, the radiation barrier has a surface with a reflectivity of about 0.4. In some embodiments, the radiation barrier has a surface with a reflectivity of about 0.5. In some embodiments, the radiation barrier has a surface with a reflectivity of about 0.45. In some embodiments, the radiation barrier has a surface with a reflectivity of about 0.55.

In some embodiments, the radiation barrier has a surface with a reflectivity of about 0.6. In some embodiments, the radiation barrier has a surface with a reflectivity of about 0.65. In some embodiments, the radiation barrier has a surface with a reflectivity of about 0.7. In some embodiments, the radiation barrier has a surface with a reflectivity of about 0.75. In some embodiments, the radiation barrier has a surface with a reflectivity of about 0.80. In some embodiments, the radiation barrier has a surface with a reflectivity of about 0.85. In some embodiments, the radiation barrier has a surface with a reflectivity of about 0.9. In some embodiments, the radiation barrier has a surface with a reflectivity of about 0.95. In some embodiments, the reflectivity of the radiation barrier 16 may have a relatively low reflectivity through either design or deterioration.

In some embodiments, the radiation barrier 16 comprises a high temperature capable nickel based alloy resistant to surface oxidation which reduces reflectivity. In other embodiments, an aluminizing process may be used to create a stable low emissivity surface. In some embodiments, the radiation barrier 16 comprises aluminized nickel. The aluminizing process may include a heat treatment to promote a stable alumina film that prevents significant further changes in emissivity. In other embodiments, the aluminizing process may be applied to the spar 52 directly to aluminize the outermost surface 60 of the spar 52.

In some embodiments, the radiation barrier 16 may comprise other oxide forming species. In other embodiments, the radiation barrier 16 may comprise an addition of a coating such as alumina to create a stable low emissivity surface.

In some embodiments, the radiation barrier 16 may comprise an oxide/oxide composite such as alumina fiber reinforced alumina. In other embodiments, the radiation barrier 16 may comprise an oxide dispersion strengthened or mechanically alloyed material, which has been specifically engineered to have high temperature stability and oxidation resistance. In some embodiments, the radiation barrier 16 may have a low conductivity such as in the oxide/oxide composite.

The radiation barrier 16 is spaced apart from the vane 12 and the support strut 14 to separate the cooling channel 62 into an outer gap 72 and an inner gap 74 as suggested in FIG. 4. The radiation barrier 16 is spaced apart from the interior surface 48 of the aerofoil 24 at all locations between the first radius r1 (the outer boundary 26) and the second radius r2 (the inner boundary 28).

The radiation barrier 16 includes an innermost surface 64, a shield surface 66, a radial outer end 68, and a radial inner end 70 as shown in FIG. 4. The innermost surface 64 is spaced apart from the outermost surface 60 of the spar 56 to define the inner gap 74. The shield surface 66 is spaced apart from the innermost surface 64 and faces opposite the outermost surface 60 of the spar 56 towards the interior surface 48 of the aerofoil 24. The shield surface 66 is spaced apart from the interior surface 48 of the aerofoil 24 to define the outer gap 72. The gaps 72, 74 may help reduce convective heat transfer from the vane 12 to the support strut 14.

In some embodiments, the radiation barrier 16 may not be spaced apart from the vane 12 and the support strut 14 leaving no inner or outer gaps 72, 74. For example, the spar may be aluminized directly leaving no gaps 72, 74. In other embodiments, the gaps 72, 74 may be small.

The radial outer end 68 engages and is coupled with the radiation barrier contact supports 59 to locate the radiation barrier 16 between the vane 12 and the support strut 14 in the cooling channel 62 as shown in FIG. 4. The radiation barrier 16 is rigid such that it supports itself in spaced apart relation to the vane 12 and the support strut 14 while being cantilevered from the supports 59. The radial inner end 70 is radially spaced apart from the radial outer end 68 relative to the axis 11 and located outside the primary gas path 21. The radiation barrier 16 does not receive any aerodynamic loading from the vane 12 or the spar 14.

Additionally, the radiation barrier 16 extends radially entirely between the radial inner surface 32 of the outer wall 20 and the radial outer surface 38 of the inner wall 22. In the illustrative embodiment, the radiation barrier 16 extends radially outward beyond the radial inner surface 32 of the outer wall 20 and radially inward of the radial outer surface 38 of the inner wall 22.

In the illustrative embodiment, a portion of the radiation barrier 16 extends to and shields at least a portion of the load transfer tab 58 of the support strut 14. The radiation barrier 16 covers the load transfer tab 58 to reduce the radiative and convective heating to the load transfer tab 58 and the aerofoil 24 so that the load transfer tab 58 of the support strut 14 is shielded from the radiant and convective heating.

The seal 18 engages the aerofoil 24 of the vane 12 and the support strut 14 to block fluid from flowing in the cooling channel 62. In some embodiments, the seal 18 is omitted. Cooling air from the compressor of a gas turbine engine, for example, could be conducted into the outer gap 72. The radiation barrier 16 would act to block the cooling air from entering the inner gap 74 such that the air in the inner gap 74 would act as an insulator against the heat added to the cooling air from the vane 12. In other embodiments, cooling air from the compressor of a gas turbine engine, for example, could be conducted into the inner gap 74. The radiation barrier 16 would act to block the cooling air from entering the outer gap 72. In other embodiments, cooling air from the compressor of a gas turbine engine, for example, could be conducted into the inner gap 74 and the outer gap 76.

A method of making the turbine vane assembly 10 may include several steps. The method includes providing the metallic support strut 14, the ceramic matrix composite aerofoil 24 formed to define the interior cavity 30 therein, and the radiation barrier 16. The method includes locating the metallic support strut 14 in the interior cavity 30 of the ceramic matrix composite aerofoil 24 so that at least a portion of the metallic support strut 14 is spaced apart from the ceramic matrix composite aerofoil 24 to define the radially extending cooling channel 62 therebetween. The method includes locating the radiation barrier 16 in the cooling channel 62 so that at least a portion of the radiation barrier 16 is spaced apart from the metallic support strut 14 and the ceramic matrix composite aerofoil 24 to separate the cooling channel 62 into an inner gap 74 and an outer gap 76. The method may include blocking airflow into the cooling channel 62. The method may include conducting airflow into the cooling channel 62.

The method may include aluminizing the radiation barrier 16 to create a stable low emissivity surface. The aluminizing step may include a heat treatment to promote a stable alumina film that prevents significant further changes in emissivity.

The method may include aluminizing the spar 52 directly to aluminize the outermost surface 60 of the spar 52. In such embodiments, the cooling channel may not be separated into inner and outer gaps.

The present disclosure relates to methods to reduce radiative and convective heat transfer to the metallic spar 56 used in a ceramic matrix composite (CMC) nozzle guide vane assembly 10, for example, in the second stage high-pressure turbine. In illustrative embodiments, the radiation barrier 16 is installed between the ceramic matrix composite vane 12 and metal surfaces of the support strut 14 with high reflectivity to shield the metal from the radiative heating effect. In some embodiments, a low emissivity coating may be applied to the spar 56 to shield the metal from the radiative heating effect.

In instances when the ceramic matrix composite material needs convective cooling, the support strut 14 may need to be isolated from the fluid as it heats before exiting the ceramic matrix composite structure. A thermal barrier coating (TBC) may be applied to the spar 56 to convectively cool the metal structure. The metal roughness of the outermost surface of the spar 56 may be reduced to minimize the heat transfer coefficient and increase convective cooling. In such embodiments, the spar 56 may be free of any coating or shield. The CMC-metal cavity may be designed to avoid accelerating the fluid.

In other embodiments, the vanes are metallic and do not need sparred supports and therefore do not need CMC cooling. However, the CMC cooling requirements may depend on the material temperature capability and engine cycle design.

Ceramic matrix composite materials may offer a higher temperature capability than conventional nickel based superalloys used in gas turbine engines. The CMC material may allow for a reduction in cooling air flow used and consequently an increase in thermal efficiency and therefore reduced fuel burn.

One component which may benefit from the substitution of nickel based superalloy with CMC materials is the second stage high pressure turbine nozzle guide vane. The vanes need to support an inter-stage seal and due to the relatively low strength of SiC/SiC CMC materials, a metallic support structure or spar may be used to transmit the axial loading applied to the inter-stage seal to the high-pressure turbine casing. Metallic nozzle guide vanes may be able to withstand the loading associated with the inter-stage seal loading without the need for a dedicated structure.

As the temperature capability of the CMC material increases the integrity and durability of the metallic support structure may decrease. The strength of the metal may reach a break-point where the material is insufficiently capable of tolerating the stresses. Additionally, the modulus of the metal structure decreases with temperature and drives a larger deflection relative to the CMC material, potentially overloading the CMC structure.

Regardless of the CMC material capability, there may be a non-trivial radiative heat load that is inputted to the metallic spar. The radiative heat load may increase exponentially with CMC operating temperature. The exponentially increasing radiative heat load may be an issue in the high pressure stage 2 turbine application, as the metal structure exists wholly within the very hot CMC structure and thus attracts a relatively large view factor.

A low emissivity coating may be applied to the support strut 14 and may be an explicit coating or doping of the thermal barrier coating, e.g. Gadolinium oxide doped Yttria stabilized Zirconia. Alternatively, the low emissivity coating may be a surface treatment applied to the spar 56 to increase its reflectivity, e.g. polishing. In some embodiments, low emissivity coatings such as alumina may be applied.

In some embodiments, a thermal barrier shield is applied to the support strut 14 and comprises a high-temperature capability thermal barrier coating with alloying additions to control transmission of optical and infrared wavelengths and to lower the thermal conductivity of the layer. In some embodiments, the alloying additions may include Gadolinium oxide.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine vane assembly for a gas turbine engine, the turbine vane assembly comprising
a ceramic matrix composite vane adapted to conduct hot gases flowing through a primary gas path of the gas turbine engine around the turbine vane assembly during use of the turbine vane assembly, the ceramic matrix composite vane includes an outer wall that defines an outer boundary of the primary gas path, an inner wall spaced apart radially from the outer wall relative to an axis to define an inner boundary of the primary gas path, and an aerofoil that extends radially between and interconnects the outer wall and the inner wall, and the aerofoil is formed to define an interior cavity that extends radially into the aerofoil,
a metallic support strut located in the interior cavity formed in the aerofoil and configured to receive force loads applied to the ceramic matrix composite vane by the hot gases during use of the turbine vane assembly, the metallic support strut being spaced apart from the aerofoil at all locations radially between the outer boundary and the inner boundary of the primary gas path to define a cooling channel between the metallic support strut and the aerofoil, and
a radiation barrier located in the cooling channel and spaced apart from the metallic support strut and the aerofoil at all locations radially between the outer boundary and the inner boundary of the primary gas path to reduce an amount of heat transfer to the metallic support strut from radiant and convective heating caused by a temperature difference between the ceramic matrix composite vane and the metallic support strut during use of the turbine vane assembly.

2. The turbine vane assembly of claim 1, wherein a surface of the radiation barrier has a reflectivity equal to or greater than about 0.5.

3. The turbine vane assembly of claim 2, wherein an air gap is located between radiation barrier and the metallic support strut and an air gap is located between the radiation barrier and the aerofoil.

4. The turbine vane assembly of claim 1, wherein the radiation barrier comprises a nickel based alloy.

5. The turbine vane assembly of claim 2, wherein the metallic support strut includes a spar that extends radially into the interior cavity and a load transfer tab that extends circumferentially away from the spar and engages the aerofoil to receive the force loads applied to the ceramic matrix composite vane by the hot gases during use of the turbine vane assembly.

6. The turbine vane assembly of claim 5, wherein the load transfer tab is located radially outward out of the outer boundary.

7. The turbine vane assembly of claim 5, wherein the radiation barrier is rigid and solid without holes that extend circumferentially or axially through the radiation barrier.

8. The turbine vane assembly of claim 1, further comprising a seal located between the aerofoil and the metallic support strut to block fluid from flowing into the cooling channel.

9. The turbine vane assembly of claim 1, wherein the radiation barrier is the only component located in the cooling channel radially between the outer boundary and the inner boundary of the primary gas path.

10. A turbine vane assembly for a gas turbine engine, the turbine vane assembly comprising
a vane that extends radially relative to an axis and the vane formed to define an interior cavity therein,
a support strut located in the interior cavity and at least a portion of the support strut being spaced apart from the vane to define a radially extending cooling channel between the support strut and the vane, and
a radiation barrier located in the cooling channel.

11. The turbine vane assembly of claim 10, wherein the vane includes an outer wall having a radial inner surface, an inner wall having a radial outer surface, and an aerofoil that extends radially between and interconnects the outer wall and the inner wall.

12. The turbine vane assembly of claim 11, wherein the radial outer wall defines a radial outer boundary of a gas path, the radial inner wall defines a radial inner boundary of the gas path, and the radiation barrier extends radially entirely between the radial outer boundary and the radial inner boundary.

13. The turbine vane assembly of claim 12, wherein the radiation barrier extends radially outward beyond the radial outer boundary and radially inward beyond the radial inner boundary.

14. The turbine vane assembly of claim 11, wherein the radiation barrier is the only component located in the cooling channel radially between the radial outer surface and the radial inner surface.

15. The turbine vane assembly of claim 10, wherein the radiation barrier has a surface with a reflectivity equal to or greater than about 0.7.

16. The turbine vane assembly of claim 10, wherein the radiation barrier is continuous and formed without holes that extend either axially or circumferentially through the radiation barrier.

17. The turbine vane assembly of claim 10, further comprising a seal that engages the vane and the support strut to block fluid flow in the cooling channel.

18. A method comprising
providing a metallic support strut, a ceramic matrix composite aerofoil formed to define an interior cavity therein, and a radiation barrier,
locating the metallic support strut in the interior cavity of the ceramic matrix composite aerofoil so that at least a portion of the metallic support strut is spaced apart from the ceramic matrix composite aerofoil to define a radially extending cooling channel therebetween, and
locating the radiation barrier in the cooling channel so that at least a portion of the radiation barrier is spaced apart from the metallic support strut and the ceramic matrix composite aerofoil to separate the cooling channel into an inner gap and an outer gap.

19. The method of claim 18, further comprising blocking airflow in the cooling channel.

20. The method of claim 18, wherein the radiation barrier has a surface with a reflectivity equal to or greater than about 0.7.
